(19) United States
(12) Patent Application Publication
(10) Pub. No.: US 2002/0076632 A1
(43) Pub. Date: Jun. 20, 2002

(54) High mobility charge transporting molecules for a charge transport layer

(75) Inventors: John F. Yanus, Webster, NY (US); Damador M. Pai, Fairport, NY (US); Markus R. Silvestri, Fairport, NY (US); Timothy J. Fuller, Pittsford, NY (US); Andronique Ioannidis, Webster, NY (US)

Correspondence Address: OLIFF & BERRIDGE, PLC, P.O. Box 19928, Alexandria, VA, 22320, US

(73) Assignee: Xerox Corporation

(21) Appl. No.: 09/976,061

(22) Filed: Oct. 15, 2001

Related U.S. Application Data
(63) Continuation-in-part of application No. 09/610,648, filed on Jun. 30, 2000, now abandoned.

(51) Int. Cl. G03G 5/047

(52) U.S. Cl. 430/58.75; 430/73; 430/74

(57) ABSTRACT

Aryldiamine charge transporting molecules for a charge transport layer of an imaging member have a higher mobility by increasing the number of phenyl groups between the nitrogen atoms of the aryldiamine. The aryldiamine has the formula

(X-Ph)(Y-Ph)-N-(Ph)ₙ-N-(Ph-Y)(Ph-X),

wherein Ph represents a phenyl group and in which (Ph)ₙ consists of ortho- and/or para-conjugated unsubstituted phenyl groups, X represents a hydrogen atom or an alkyl group having from 1 to about 20 carbon atoms, Y represents a hydrogen atom or an alkyl group having from 1 to about 20 carbon atoms, and n is an integer greater than 3. A charge transport layer is prepared by molecularly dispersing or dissolving the aryldiamine charge transporting molecule in a polymeric binder.

### BACKGROUND OF THE INVENTION

1. Field of the Invention

The invention relates to high mobility charge transport molecules for transporting charges injected into a charge transport layer of a photoreceptor across the charge transport layer.

2. Description of Related Art

In the art of electrophotography (also known as xerography), an electrophotographic imaging member containing a photoconductive insulating layer is imaged by first uniformly electrostatically charging the imaging surface of the imaging member, for example with the use of a corotron. The imaging member is then exposed to a pattern of activating electromagnetic radiation such as light which selectively dissipates the charge in the illuminated areas of the photoconductive insulating layer while leaving behind an electrostatic latent image in the non-illuminated areas. The electrostatic latent image may then be developed to form a visible image by depositing finely divided electroscopic marking particles on the surface of the photoconductive insulating layer.

Layered or composite imaging members, including flexible imaging members, are well known in the art. One such device contains a support layer, a photogenerating layer and a charge transport layer as described in U.S. Pat. No. 4,265,990, incorporated herein by reference in its entirety. Another layered imaging member is comprised of a substrate, overcoated with a hole injecting layer, which in turn is overcoated with a transport layer, a photogenerating layer, and finally a top coating of an organic insulating resin, as described in, for example, U.S. Pat. No. 4,251,612, also incorporated herein by reference in its entirety.

The charge (or hole) transport layer is typically comprised of charge transporting molecules dissolved in a polymeric matrix, the layer being substantially non-absorbing in a spectral region of intended use, for example, visible light, while also being active in that the injection of photogenerated charges from the charge photogenerating layer can be accomplished. Further, the charge transport layer allows for the efficient transport of positive charges to the surface of the transport layer. Charge transport layers may comprise, for example, hole transporting molecules such as diamines dispersed in a continuous polymeric binder.

One of the design criteria for the selection of the photosensitive pigment for a charge generator layer and the charge transport molecule for a transport layer is that, when light photons photogenerate charges in the pigment, the charges be efficiently injected into the charge transport molecule in the transport layer. More specifically, the injection efficiency from the pigment to the transport layer should be high. A second design criterion is that the injected charges be transported across the charge transport layer in a short time, in particular shorter than the time duration between the exposing and developing steps in an imaging device. The transit time across the transport layer is determined by the charge carrier mobility in the transport layer. The charge carrier mobility is the velocity per unit field and has dimensions of cm²/V sec. The charge carrier mobility is generally a function of the structure of the charge transporting molecule, the concentration of the charge transporting molecule in the transport layer and the electrically “inactive” binder polymer in which the charge transport molecule is dispersed.

A property of significance in multilayer photoreceptors is thus the charge carrier mobility in the charge transport layer. The charge carriers are photogenerated in the charge generator layer and injected into the charge transport layer during the exposure step (assuming the delayed release of carriers from the pigment into the charge transport layer is short). Charge carrier mobility must be high enough to move the charges injected into the charge transport layer during the exposure step across the transport layer during the time interval between the exposure step and the development step.

Thus, charge carrier mobility determines the velocity at which the photoinjected carriers transit the transport layer. To achieve maximum discharge or sensitivity for a fixed exposure, the photoinjected carriers must transit the transport layer before the imagewise exposed region of the photoreceptor arrives at the development station. To the extent the carriers are still in transit when the exposed segment of the photoreceptor arrives at the development station, the discharge is reduced and hence the contrast potentials available for development are also reduced.

At the low end of the throughput (prints per minute) market, the size of the xerographic printers has been reduced by employing small size components; the photoconductor (PC) drum size has been reduced to as low as 20 mm in diameter and even lower; the trend is to increase the throughput in these small size machines by increasing the speed (revolutions per minute) of the PC drum. Since the charging, exposure, and development stations are mounted around the circumference of the drum, the time between the exposure and development stations goes down as the drum rpm is increased. The charge carrier mobilities of the transport layers for use in these small drum diameter high speed machines have to be considerably higher than the value of about 10⁻⁵ cm²/(volt sec) that is currently available at 50 weight per cent concentration of the charge transport molecules. The transit time of the charge carriers across the transport layer and charge carrier mobility are related to each other by the expression transit time=(transport layer thickness)²/(mobility X applied voltage)

For greater charge carrier mobility capabilities, it is conventional in the art to increase the concentration of the active small molecule transport material dissolved or molecularly dispersed in the binder. Phase separation or crystallization sets an upper limit to the concentration of the transport molecules that can be dispersed in a binder. One way of increasing the solubility limit of the transport molecule is to attach long alkyl groups onto the transport molecules. However, these alkyl groups are “inactive” and do not transport charge. For a given concentration of the transport molecules, these side chains actually reduce the charge carrier mobility. A second factor that reduces the charge carrier mobilities is the dipole content of the charge transport molecules, their side groups as well as that of the binder in which the molecules are dispersed.

U.S. Pat. No. 4,780,385 describes an electrophotographic imaging member having an imaging surface adapted to receive a negative charge, metal ground plane comprising zirconium, a hole blocking layer, a charge generating layer comprising photoconductive particles dispersed in a film-forming resin binder and a hole transport layer. It is disclosed that the charge transport layer can contain a film-forming binder and an aromatic amine. Various aromatic amines are described.

U.S. Pat. No. 5,053,304 describes a photoconductive element suitable for a multiple electrophotographic copying from a single imaging step. The element preferably incorporates a charge generation layer which comprises a phthalocyanine dye or pigment. The copying method involves simultaneous application of corona charge and image exposure to the element followed by uniform radiation of the element. Thereafter a plurality of copies can be made by the same step of toner deposition, toner transfer and toner heat fusion to a receiver. The photoconductor comprises a charge transport layer and at least one aromatic amine hole transport agent and an electrically insulated film-forming organic polymeric binder, a charge generation layer comprising at least one photoconductive phthalocyanine material, an adhesive layer, a solvent holdout layer, an electrically insulating layer, an electrically conductive layer and a support layer. The aromatic amine hole transport agent may be, for example, 1,1-bis(di-4-tolylaminophenyl)cyclohexane or a mixture of tri-4-tolyamine and 1,1-bis(di-4-tolylaminophenyl)cyclohexane.

U.S. Pat. No. 4,265,990 describes a photosensitive member comprising a photoconductive layer and a charge transport layer. The charge transport layer comprises a polycarbonate resin and one or more diamine compounds represented by a certain structural formula.

U.S. Pat. No. 4,273,846 describes a charge generation layer comprising a layer of photoconductive material and a contiguous charge transport layer of an electrically inactive polycarbonate resin material having dispersed therein from about 25 to about 75 percent by weight of one or more of terphenyl diamine compounds.

U.S. Pat. No. 4,297,425 describes a layered photosensitive member comprising a generator layer and a transport layer containing a combination of diamine and triphenyl methane molecules dispersed in a polymeric binder.

U.S. Pat. No. 4,050,935 describes a layered photosensitive member comprising a generator layer of trigonal selenium and a transport layer of bis(4-diethylamino-2-methylphenyl)phenylmethane molecularly dispersed in a polymeric binder.

U.S. Pat. No. 4,457,994 describes a layered photosensitive member comprising a generator layer and a transport layer containing a diamine type molecule dispersed in a polymeric binder and an overcoat containing triphenyl methane molecules dispersed in a polymeric binder.

U.S. Pat. No. 4,281,054 describes an imaging member comprising a substrate, an injecting contact, or hole injecting electrode overlying the substrate, a charge transport layer comprising an electrically inactive resin containing a dispersed electrically active material, a layer of charge generator material and a layer of insulating organic resin overlying the charge generating material. The charge transport layer can contain triphenylmethane.

U.S. Pat. No. 4,599,286 describes an electrophotographic imaging member comprising a charge generation layer and a charge transport layer, the transport layer comprising an aromatic amine charge transport molecule in a continuous polymeric binder phase and a chemical stabilizer selected from the group consisting of certain nitrone, isobenzofuran, hydroxyaromatic compounds and mixtures thereof An electrophotographic imaging process using this member is also described.

U.S. Pat. No. 6,025,102, incorporated herein by reference in its entirety, describes a flexible electrophotographic imaging member including a supporting substrate coated with at least one imaging layer comprising charge transport material free of long chain alkyl carboxylate groups and a small amount of a different second hole transporting material containing at least two long chain alkyl carboxylate groups dissolved or molecularly dispersed in a film forming binder and coated from a mixture of solvents containing low boiling component and a small concentration of high boiling solvent. Examples of the first hole transporting molecule free of long chain alkyl carboxylate groups include charge transporting aromatic amines free of long chain alkyl carboxylate groups for admixing with the second different transporting material containing at least two long chain alkyl carboxylate groups include, for example, triphenylmethane, bis(4-diethylamine-2-methylphenyl)phenylmethane; 4′4″-bis(diethylamino)-2′,2″-dimethyltriphenyl-methane, N,N′-bis(alkylphenyl)-{1,1′-biphenyl}4,4′-diamine wherein the alkyl is, for example, methyl, ethyl, propyl, n-butyl, etc., N,N′-diphenyl-N,N′-bis(chlorophenyl)-{1,1′-biphenyl}-4,4′-diamine, N,N′-diphenyl-N,N′-bis(3″-methylphenyl)-(1,1′-biphenyl)4,4′-diamine, and the like. Preferably, the flexible electrophotographic imaging member is free of an anticurl backing layer, the imaging member comprising a supporting substrate uncoated on one side and coated on the opposite side with at least a charge generating layer and a charge transport layer containing comprising a first charge transport material and a small amount of a different second hole transporting material containing at least two long chain alkyl carboxylate groups dissolved or molecularly dispersed in a film forming binder and coated from a mixture of solvents containing low boiling component and a small concentration of high boiling solvent.

U.S. Pat. No. 5,725,986, incorporated herein by reference in its entirety, describes an imaging process including providing an electrophotographic imaging member including a substrate, a charge generating layer and a charge transport layer including a small molecule hole transporting aryldiamine, a small molecule hole transporting tritolyl amine and a film forming binder, depositing a uniform electrostatic charge on the imaging member with a corona generating device to which power is being supplied, the corona generating device comprising at least one bare metal wire adjacent to and spaced from the imaging member, exposing the imaging member with activating radiation in image configuration to form an electrostatic latent image, developing the latent image with marking particles to form a toner image, transferring the toner image to a receiving member, repeating the depositing, exposing, developing, transferring steps, resting the imaging member for at least 15 minutes under the corona generating device while the power to the corona generating device is removed and while the corona generating device is emitting sufficient effluents to render the surface region of the electrophotographic imaging member underlying the corona generating device electrically conductive if the tritolyl amine were replaced with the small molecule hole transporting aryldiamine, supplying power to the corona generating device, and repeating the depositing, exposing, developing, transferring steps at least once.

What is still desired are higher mobility charge transport molecules capable of moving charges across the charge transport layer more quickly and efficiently.

### SUMMARY OF THE INVENTION

It is, therefore, one object of the present invention to provide novel charge transport molecules exhibiting high charge carrier mobilities. It is also an object of the present invention to provide an electrophotographic imaging member that exhibits high charge carrier mobilities. It is also an object of the present invention to increase the charge carrier mobility to be able to enable a reduction in the time between exposure and development.

These and other objects are accomplished in accordance with this invention by providing an electrophotographic imaging member comprising a charge generating layer and a charge transport layer, wherein the charge transport layer contains a charge transporting molecule that is a particular type of aryldiamine containing more than 3 ortho- or para-conjugated unsubstituted phenyl groups between the nitrogen atoms dissolved or molecularly dispersed in a non-charge transporting binder polymer. The imaging member may be employed in an electrophotographic imaging process.

In particular, aryldiamine charge transporting molecules for a charge transport layer of an imaging member having a higher charge carrier mobility are achieved by increasing the number of ortho- or para-conjugated unsubstituted phenyl groups between the nitrogen atoms of the aryldiamine. The aryldiamine has the formula (X-Ph)(Y-Ph)-N-(Ph)ₙ-N-(Ph-Y)(Ph-X), wherein Ph represents a phenyl group and in which (Ph)n consists of ortho- and/or para-conjugated unsubstituted phenyl groups, X represents a hydrogen atom or an alkyl group having from 1 to about 20 carbon atoms, Y represents a hydrogen atom or an alkyl group having from 1 to about 20 carbon atoms, and n is an integer greater than 3. A charge transport layer is prepared by molecularly dispersing or dissolving the aryldiamine charge transporting molecule in a polymeric binder.

### DETAILED DESCRIPTION OF PREFERRED EMBODIMENTS

Electrophotographic imaging members and electrophotographic methods of imaging with the members are well known in the art. Electrophotographic imaging members may be prepared by any suitable technique. Typically, a flexible or rigid substrate is provided with an electrically conductive surface. A charge generating (or generation) layer is then applied to the electrically conductive surface. A charge blocking layer may optionally be applied to the electrically conductive surface prior to the application of a charge generating layer. If desired, an adhesive layer may be utilized between the charge blocking layer and the charge generating layer. Usually the charge generating layer is applied onto the blocking layer and a charge transport layer is formed on the charge generation layer. This structure may have the charge generation layer on top of or below the charge transport layer.

The imaging members can be employed in any type of electrophotographic imaging device such as copiers, duplicators and printing systems. These copiers, duplicators and printing systems may utilize any of various exposure means including, for example, a laser, e.g., a gallium arsenide laser, image bars, etc. for generating the image to be developed.

The substrate of the imaging member may be opaque or substantially transparent and may comprise any suitable material having the required mechanical properties. Accordingly, the substrate may comprise a layer of an electrically non-conductive or conductive material such as an inorganic or an organic composition. As electrically non-conducting materials there may be mentioned various resins known for this purpose including polyesters, polycarbonates, polyamides, polyurethanes, and the like which are flexible as thin webs. An electrically conducting substrate may be any metal, for example, aluminum, nickel, steel, copper, and the like or a polymeric material, as described above, filled with an electrically conducting substance, such as carbon, metallic powder, and the like or an organic electrically conducting material. The electrically insulating or conductive substrate may be in the form of an endless flexible belt, a web, a rigid cylinder, a sheet and the like.

The thickness of the substrate layer depends on numerous factors, including strength desired and economical considerations. Thus, for a drum, this layer may be of substantial thickness of, for example, up to many centimeters or of a minimum thickness of less than a millimeter. Similarly, a flexible belt may be of substantial thickness, for example, about 250 micrometers, or of minimum thickness less than 50 micrometers, provided there are no adverse effects on the final electrophotographic device.

In embodiments where the substrate layer is not conductive, the surface thereof may be rendered electrically conductive by an electrically conductive coating. The conductive coating may vary in thickness over substantially wide ranges depending upon the optical transparency, degree of flexibility desired, and economic factors. Accordingly, for a flexible photoresponsive imaging device, the thickness of the conductive coating may be between about 20 angstroms to about 750 angstroms, and more preferably from about 100 angstroms to about 200 angstroms for an optimum combination of electrical conductivity, flexibility and light transmission. The flexible conductive coating may be an electrically conductive metal layer formed, for example, on the substrate by any suitable coating technique, such as a vacuum depositing technique or electrodeposition. Typical metals include aluminum, zirconium, niobium, tantalum, vanadium and hafnium, titanium, nickel, stainless steel, chromium, tungsten, molybdenum and the like.

Also particularly when a non-conductive substrate is employed, an electrically conductive ground plane may be employed, and the ground plane acts as the conductive layer. When a conductive substrate is employed, the substrate can act as the conductive layer, although a conductive ground plane may also be provided if desired. The ground plane can be applied by known coating techniques, such a solution coating, vapor deposition and sputtering. A preferred method of applying an electrically conductive ground plane is by vacuum deposition. Other suitable methods can also be used.

In some situations, it may be desirable to coat an anti-curl layer, such as polycarbonate materials commercial available as MAKROLON® from Farbenfaabricken Bayer A. G., or a copolyester resin such as Vitel PE-200 available from Goodyear Tire and Rubber Co., on the back of the substrate, particularly when the substrate is an organic polymeric material. In addition, the anti-curl coating in embodiments of the present invention may contain an adhesion promoter, preferably in an amount of up to 10% by weight of the anti-curl layer. The anti-curl layer may also contain friction and/or wear reducing agents such as silica.

An optional hole blocking layer may be applied to the substrate. Any suitable and conventional blocking layer capable of forming an electronic barrier to holes between the adjacent photoconductive layer and the underlying conductive surface of a substrate may be utilized. A preferred blocking layer may comprise, for example, a reaction product between a hydrolyzed silane and a metal oxide layer of a conductive anode. The imaging member may be prepared, for example, by depositing on the metal oxide layer of a metallic conductive anode layer a coating of an aqueous solution of the hydrolyzed silane at a pH between about 4 and about 10, drying the reaction product layer to form a siloxane film and applying an optional adhesive layer, the generating layer, and the charge transport layer to the siloxane film. Typical hydrolyzable silanes include 3-aminopropyl triethoxy silane, (N,N-dimethyl 3-amino) propyl triethoxysilane, N,N-dimethylaminophenyl triethoxy silane, N-phenyl aminopropyl trimethoxy silane, triethoxy silylpropylethylene diamine, trimethoxy silypropylethylene diamine, trimethoxy silylpropyldiethylene triamine and mixtures thereof. Generally, dilute solutions are preferred for achieving a thin coating. Satisfactory reaction product films may be achieved with solutions containing from about 0.1 percent by weight to about 1.5 percent by weight of the silane based on the total weight of the solution. Any suitable technique may be utilized to apply the hydrolyzed silane solution to the metal oxide layer of a metallic conductive layer. Typical application techniques include spraying, dip coating, roll coating, wire wound rod coating and the like. Generally, satisfactory results may be achieved when the reaction product of the hydrolyzed silane and metal oxide layer forms a layer having a thickness between about 20 Angstroms and about 2,000 Angstroms. Such a siloxane coating is described in U.S. Pat. No. 4,464,450, the disclosure being incorporated herein by reference in its entirety.

An optional adhesive layer may applied to the hole blocking layer. Any suitable adhesive layer well known in the art may be utilized. Typical adhesive layers include film-forming polymers such as polyester, duPont 49,000 resin (available from E. I. du Pont de Nemours & Co.), polyvinylbutyral, polyvinylpyrolidone, polyvinylacetate, polyurethane, polymethylmethacrylate and the like. Satisfactory results may be achieved with adhesive layer thickness between about 0.01 micrometer (100 angstroms) and about 5 micrometers. Conventional techniques for applying an adhesive layer coating mixture to the charge blocking layer include spraying, dip coating, roll coating, wire wound rod coating, gravure coating, Bird applicator coating, and the like. Drying of the deposited coating may be effected by any suitable conventional technique such as oven drying, infrared radiation drying, air drying and the like.

Charge generation layers may comprise amorphous films of selenium and alloys of selenium and arsenic, tellurium, germanium and the like, hydrogenated amorphous silicon and compounds of silicon and germanium, carbon, oxygen, nitrogen and the like fabricated by vacuum evaporation or deposition.

The charge generator layer may also comprise inorganic pigments of crystalline selenium and its alloys, Group II-VI compounds, or organic pigments such as quinacridones, polycyclic pigments such as dibromo anthanthrone pigments, perylene and perinone diamines, polynuclear aromatic quinones, azo pigments including bis-, tris- and tetrakis-azos, and the like dispersed in a film forming polymeric binder and fabricated by solvent coating techniques. The photogenerating layer includes, for example, numerous photoconductive charge carrier generating materials provided that they are electronically compatible with the charge carrier transport layer, that is, they can efficiently inject photoexcited charge carriers into the transport layer.

The light absorbing photogeneration layer (i.e., the charge generating layer) may contain organic photoconductive pigments and/or inorganic photoconductive pigments. Typical organic photoconductive pigments include vanadyl phthalocyanine and other phthalocyanine compounds such as hydroxygallium phthalocyanine, chlorogallium pthalocyanine, metal-free phthalocyanines, metal phthalocyanines such as copper phthalocyanine, quinacridones such as, for example, available from du Pont under the tradename Monastral Red, Monastral Violet and Monastral Red Y, substituted 2,4-diamino-triazines disclosed in U.S. Pat. No. 3,442,781, squarine pigments, such as hydroxyl squarilium pigments, squarilium compounds, pyridinium compounds, azo dyes, diazo dyes, polynuclear aromatic quinones such as anthraquinome and those available from Allied Chemical Corporation under the tradename Indofast Double Scarlet and Indofast Violet Lake B, Indofast Brilliant Scarlet and Indofast Orange, thiopyrylium pigments, perylene pigments such as benzamidazole perylene, quinomeridones, or mixture thereof.

Typical inorganic photosensitive pigments include amorphous selenium, trigonal selenium, mixtures of Groups IA and IIA elements, As₂Se₃, selenium alloys, cadmium selenide, cadmium sulfo selenide, copper and chlorine doped cadmium sulfide, and mixtures thereof.

Any suitable inactive resin binder material may be employed in the charge generation layer. Typical organic polymeric film forming binders include thermoplastic and thermosetting resins such as polycarbonates, polyesters, polyamides, polyurethanes, polystyrenes, polyarylethers, polyarylsulfones, polybutadienes, polysulfones, polyethersulfones, polyethylenes, polypropylenes, polyimides, polymethylpentenes, polyphenylene sulfides, polyvinyl acetate, polysiloxanes, polyacrylates, polyvinyl acetals, polyamides, polyimides, amino resins, phenylene oxide resins, terephthalic acid resins, phenoxy resins, epoxy resins, phenolic resins, polystyrene and acrylonitrile copolymers, polyvinylchloride, vinylchloride and vinyl acetate copolymers, acrylate copolymers, alkyd resins, cellulosic film formers, poly(amideimide), styrene-butadiene copolymers, vinylidenechloride-vinylchloride copolymers, vinylacetate-vinylidenechloride copolymers, styrene-alkyd resins, polyvinylcarbazole, and the like. Many organic resinous binders are disclosed, for example, in U.S. Pat. No. 3,121,006 and U.S. Pat. No. 4,439,507, the entire disclosures of which are incorporated herein by reference. Organic resinous polymers may be block, random or alternating copolymers.

The photogenerating layer containing photoconductive compositions and/or pigments, and the resinous binder material, generally ranges in thickness of from about 0.01 micrometer to about 10 micrometers, and preferably has a thickness of from about 0.2 micrometer to about 3 micrometers. Generally, the maximum thickness of this layer is dependent primarily on factors such as mechanical considerations, while the minimum thickness of this layer is dependent on, for example, the pigment particle size, optical density of the photogenerating pigment and the like. Thicknesses outside these ranges can be selected.

The photogenerating composition or pigment is present in the resinous binder composition in various amounts, generally, however, from about 5 percent by weight to about 90 percent by weight, and preferably in an amount of from about 10 percent by weight to about 50 percent by weight of the layer. Accordingly, in this embodiment, the resinous binder is present in an amount of from about 95 percent by weight to about 20 percent by weight, and preferably in an amount of from about 90 percent by weight to about 50 percent by weight. The specific proportions selected depends to some extent on the thickness of the generator layer.

Any suitable and conventional technique may be utilized to mix and thereafter apply the photogenerating layer coating mixture. Typical application techniques include spraying, dip coating, roll coating, wire wound rod coating, vacuum sublimation and the like. For some applications, the generator layer may be fabricated in a dot or line pattern. Removing of the solvent of a solvent coated layer may be effected by any suitable conventional technique such as oven drying, infrared radiation drying, air drying and the like. The photogenerator layers can also fabricated by vacuum sublimation in a case where there is no binder.

The charge transport layer comprises a charge transporting aryldiamine small molecule dissolved or molecularly dispersed in a film forming electrically inert polymer. The term “dissolved” as employed herein is defined herein as forming a solution in which the small molecule is dissolved in the polymer to form a homogeneous phase. The term “molecularly dispersed” as used herein is defined as a charge transporting aryldiamine small molecule dispersed in the polymer, the aryldiamine being dispersed in the polymer on a molecular scale. The term charge transporting “small molecule” as used herein refers to a material that allows the free charge photogenerated in the photogenerator layer and injected into the transport layer to be transported across the transport layer.

The aryldiamine small molecule has the following structure:

(X-Ph)(Y-Ph)-N-(Ph)ₙ-N-(Ph-Y)(Ph-X)

wherein Ph represents a phenyl group and in which (Ph)ₙ consists of ortho- or para-conjugates unsubstituted phenyl groups, X represents a hydrogen atom or an alkyl group having from 1 to about 20 carbon atoms, Y represents a hydrogen atom or an alkyl group having from 1 to about 20 carbon atoms, and n is an integer greater than 3. Mixtures of two or more such aryldiamine molecules may be used in the charge transport layer.

If n is 2, Y is H and X is CH₃, the molecule is N,N′-diphenyl-N,N′-bis(3-methylphenyl)-(1,1′-biphenyl)-4,4′-diamine (TPD), a well known biphenyl diamine charge transport molecule currently in wide use:

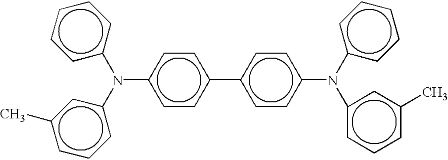

However, the present inventors have surprisingly found that with increasing n, charge carrier mobility drastically increases. For example, when n is 3, the molecule has more than an order of magnitude higher charge mobility than TPD (n=2) at equivalent concentration levels in the charge transport layer polymeric binder, especially at low voltage fields.

We have found that the charge carrier mobility increases as the number of ortho- or para-conjugated unsubstituted phenyl groups between the nitrogen atoms increases. We have also found, however, that the solubility of the charge carrier in polycarbonate goes down as the number of ortho- or para-conjugated unsubstituted phenyl groups between the nitrogen atoms increases. Therefore, in order to increase the solubility of these molecules containing higher number of ortho- or para-conjugated unsubstituted phenyl groups between nitrogen atoms, the substituent groups X and Y are preferably alkyl groups containing larger numbers of carbon atoms.

As noted above, with increasing n comes a decrease in solubility of the charge transport molecule in the polymeric binder. However, even at only 25% by weight loading in the binder, a molecule with n=4 exhibits twice as much charge mobility as a molecule with n=3 at 50% by weight loading in the polymeric binder.

Most preferably, n is preferably greater than 3, and is most preferably between 4 and 10, for example equal to any of 4, 5, 6, 7, 8, 9, 10 or any range therein. Having n greater than 10 is, of course, also possible, although as noted above, solubility of the molecule in the charge transport layer polymeric binder is decreased the greater n is. This can be offset to some extent by having X or Y represent alkyl groups with larger numbers of carbon atoms, for example about 5 to about 20 carbon atoms, as discussed above.

Suitable aryldiamines of the present invention include: Tetraphenyl diamine

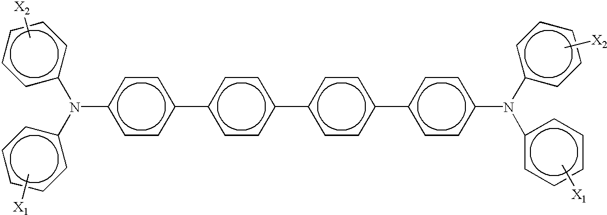

The concentration of the aryldiamine charge transporting molecules in the transport layer may be between, for example, about 10 and about 80 percent by weight, preferably between about 10 and about 70 percent by weight, most preferably between about 10 and about 50 percent by weight, based on the total weight of the charge transporting components in the dried transport layer. When the proportion of total small molecule hole transporting molecule in the dried transport layer is less than about 10 percent by weight, the charge transporting properties of the layer is reduced such that the surface voltage in the image exposure area is not reduced within the time duration of the exposure and development stations and therefore no development will occur. When the proportion of total small molecule charge transport material in the transport layer exceeds about 80 percent by weight based on the total weight of the dried overcoating layer, crystallization may occur resulting in residual cycle-up. Also, the mechanical properties of the film may be adversely degraded resulting in surface cracking and delamination of the layers from each other. Such degradation will significantly reduce the useful life of the device. For application in machines employing drums of 20 mm or less and operated at high speed, charge carrier mobilities in excess of 10³¹ cm²/(volt sec) is required.

As discussed above, a useful imaging member must be designed so that the charges supplied into the transport layer during the exposure step traverse the transport layer within the time interval between the exposure and development steps. This sets a lower limit on the charge carrier mobility, particularly at the tail end of a Photo-Induced Discharge Characteristic (PIDC, which is the sensitivity curve of the imaging member) of the device where the voltages are lower and thus the charge carrier velocity (which is a product of mobility and electric field) is lower.

The demand for higher throughput imaging devices (e.g., copiers) continues to increase, and this requires higher operating speeds, which in turn requires higher mobility charge transport molecules. The charge transport molecules of the present invention satisfy this great demand.

Another advantage of the high mobility charge transport molecules of the invention is that as a result of the higher mobility, the molecules can be used in lower concentrations in the charge transport polymer binder. This is because increasing the concentration level of the molecules increases the mobility, and thus higher mobilities can be achieved even at lower concentrations compared to conventional imaging members that employ, for example, TPD transport molecules. This in turn has the advantage of reducing the wear rates of the imaging members because higher concentrations of charge transport molecules results in higher wear rates of the imaging members as understood in the art, and thus it is very advantageous to be able to operate at lower concentrations of charge transport molecules.

Thus, the invention has the advantages of achieving higher mobility at lower charge transport molecule concentrations, lower unit manufacturing cost, improved device performance in terms of higher throughput and smaller size, e.g., smaller diameter drums, particularly at lower voltage fields, and improved photoreceptor wear.

Any suitable electrically inactive polymeric film forming resin binder may be utilized in the charge transport layer. The inert highly insulating resinous binder is a material which is not necessarily capable of supporting the injection of holes from the photogenerator layer, and is not capable of allowing the transport of these holes through the material. Typical inactive resin binders include polycarbonate resins, for example commercially available as Makrolon, Merlon and Lexan, polyesters, polystyrenes, polyarylates, polyacrylates, polyethers, polysulfones, mixtures thereof, and the like. Weight average molecular weights can vary and may be, for example, from about 8,000 to about 1,500,000, preferably 20,000 to 150,000 An electrically inert polymeric binder generally used to disperse the electrically active molecule in the charge transport layer includes poly(2,2′-methyl-4,4′-isopropylidenediphenylene)carbonate (also referred to as bisphenol-C-polycarbonate), poly(4,4′-isopropylidene-diphenylene)carbonate (also referred to as bisphenol-A-polycarbonate) and poly(4,4′-diphenyl-1,1′-cyclohexane carbonate) (also referred to as bisphenol-Z-polycarbonate).

The charge transport layer of the imaging member may also contain additional additives, for example antioxidants, etc.

Any suitable and conventional technique may be utilized to mix and thereafter apply the charge transport layer coating mixture to the imaging member. Typical application techniques include spray coating, dip coating, roll coating, wire wound rod coating, and the like. A coating solvent such as methylene chloride, toluene, monochloro benzene and the like may be used in forming the charge transport layer. Drying of the deposited coating may be effected by any suitable conventional technique such as oven drying, infrared radiation drying, air drying and the like.

The charge transport layer should be an insulator to the extent that the electrostatic charges placed on the imaging surface of the photoreceptor are not conducted or discharged in the absence of illumination at a rate sufficient to prevent formation and retention of an electrostatic latent image thereon. In other words, the charge transport layer, is substantially non-absorbing to visible light or radiation in the region of intended use but is electrically “active” in that it allows the injection of photogenerated holes from the photoconductive layer, i.e., charge generation layer, and allows these holes to be transported through itself to selectively discharge a surface charge on the surface of the active layer.

Generally, the thickness of the charge transport layer is between about 10 and about 50 micrometers, but thicknesses outside this range can also be used. In general, the ratio of the thickness of the charge transport layer to the charge generator layer is preferably maintained from about 2:1 to about 200:1 and in some instances as great as about 400:1.

Optionally, an overcoating layer may also be utilized to improve resistance to abrasion. These overcoating layers may comprise organic polymers or inorganic polymers that are electrically insulating or slightly semi-conductive. The overcoating layer generally ranges in thickness of from about 0.05 micrometer to about 10 micrometers, and preferably has a thickness of from about 0.2 micrometer to about 5 micrometers and comprises materials that are capable of absorbing ultraviolet light so as to minimize ultraviolet light degradation of the materials contained in the transport layer and/or in the photogenerating layer. Also, this overcoating layer can function as a protective layer for the photoresponsive device.

The photoconductive imaging member described herein can be incorporated into various imaging systems such as those conventionally known as xerographic imaging devices. Additionally, the imaging members of the present invention can be selected for imaging and printing systems with visible, near-red and/or infrared light. In this embodiment, the photoresponsive devices may be negatively or positively charged, exposed to light having a wavelength of from about 700 to about 900, and preferably 740 to 800 nanometers, such as generated by solid state layers, e.g., arsenide-type lasers, either sequentially or simultaneously, followed by developing the resulting image and transferring it to a print substrate such as transparency or paper. Additionally, the imaging members of the present invention can be selected for imaging and printing systems with visible light. In this embodiment, the photoresponsive devices may be negatively or positively charged, exposed to light having a wavelength of from about 400 to about 700 nanometers, followed by development with a known toner, and then transferring and fixing of the image on a print substrate.

The present invention also encompasses a method of generating images with the photoconductive imaging members disclosed herein. The method generally comprises the steps of first charging the imaging member with a corona charging device such as, for example, a corotron, dicorotron, scorotron, pin charging device, bias charging roll (BCR) or the like. Then, an electrostatic image is generated on the photoconductive imaging member with an electrostatic image forming device such as discussed above. Subsequently, the electrostatic image is developed by known developing devices at one or more developing stations that apply developer compositions such as, for example, compositions comprised of resin particles, pigment particles, additives including charge control agents and carrier particles, etc., reference being made to U.S. Pat. Nos. 4,558,108; 4,560,535; 3,590,000; 4,264,672; 3,900,588 and 3,849,182, the disclosures of each of these patents being totally incorporated herein by reference. The developed electrostatic image is then transferred to a suitable print substrate such as paper or transparency at an image transfer station, and affixed to the substrate. Development of the image may be achieved by a number of methods, such as cascade, touchdown, powder cloud, magnetic brush, and the like.

Transfer of the developed image to a print substrate may be by any suitable method, including those wherein a corotron or a biased roll is selected. The fixing step may be performed by means of any suitable method, such as flash fusing, heat fusing, pressure fusing, vapor fusing, and the like.

Following transfer of the developed image from the imaging member surface, the imaging member is preferably cleaned of any residual developer remaining on the surface, and also cleaned of any residual electrostatic charge prior to being subjected to charging for development of a further or next image.

### COMPARATIVE EXAMPLE I

### Preparation of N,N′-diphenyl-N,N′-bis{3-methylphenyl}-1,4-phenylenediamine

A 250 milliliter three-necked round bottom flask, equipped with a mechanical stirrer and purged with argon, was charged with 14.6 grams (0.08 moles) of 3-methylphenylphenylamine, 6.6 grams (0.02 moles) of 1,4-diiodobenzene, 9 grams (0.16 moles) of potassium hydroxide, 6 grams of copper powder and 12 milliliters Soltrol® 170 or Isopar M® hydrocarbons. The mixture was heated with stirring for 4 hours in a 165° C. oil bath The product was isolated by the addition of 200 milliliters of octane and hot filtered to remove inorganic solids. The product crystallized out upon cooling and was isolated by filtration. Treatment with alumina yielded pure N,N′-diphenyl-N,N′-bis {3-methylphenyl}-1,4-phenylenediamine in approximately 81% yield. The structure of this molecule (#1) is:

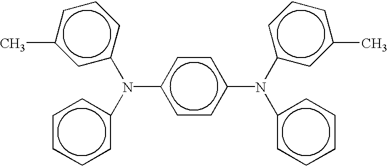

### COMPARATIVE EXAMPLE II

### Preparation of N,N′-diphenyl-N,N′-bis{3-methylphenyl} { 1,1′-biphenyl}4,4′-diamine (TPD)

A 500 milliliter three-necked round bottom flask equipped with an argon purge, a condenser and a mechanical stirrer was charged with 81.2 grams (0.2 moles) of 4,4′-diiodobiphenyl, 146.4 grams (0.8 moles) of 3-methyl phenylphenylamine, 89.6 grams (1.6 moles) of KOH flake and 80 grams (1.0 moles) of copper powder. The flask was immersed in a 165° C. oil bath and the two-phase melt was stirred for 3 hours. Hot (140° C.) Soltrol® 170 was added and the inorganic solids separated by vacuum filtration. On cooling, the product crystallized from the filtrate and was isolated in 89% yield by filtration. Purification was accomplished by slurrying the product with neutral alumina (10 grams) over argon in one liter Soltrol® 170 at 150° C. for 6 hours. The alumina was removed by hot filtration and the product crystallized from the filtrate on cooling. Overall yield was 85%. The structure of this molecule (#2) is:

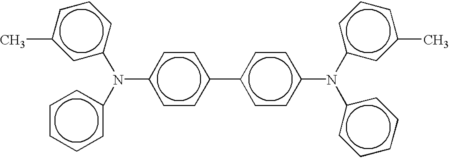

### COMPARATIVE EXAMPLE III

### Preparation of Terphenyl Diamine

A 250 milliliter three-necked round bottom flask, equipped with a mechanical stirrer and purged with argon was charged with 14.3 grams (0.06 moles) of 3-methyl-4″-(1-butyl)diphenylamine, 9.6 grams (0.02 moles) of 4′,4″-diiodoterphenyl, 15 grams (0.11 moles) of potassium carbonate, 10 grams of copper bronze and 50 milliliters Soltrol® 170 or Isopar M® hydrocarbons. The mixture was heated for 18 hours at 210° C. The product was isolated by the addition of 200 milliliters of octane and hot filtered to remove inorganic solids. The product crystallized out upon cooling and was isolated by filtration. Treatment with alumina yielded pure N,N′-bis(3-methylphenyl)-N,N′-bis(4-n-butylphenyl)(p-terphenyl)-4,4′-diamine in approximately 75% yield. The structure of this molecule (#3) is:

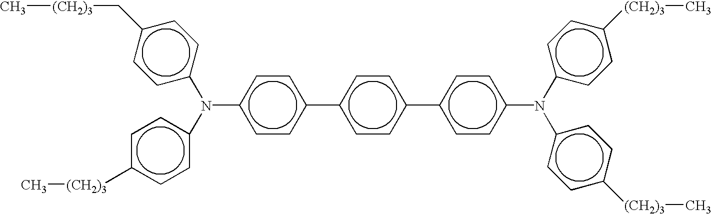

### EXAMPLE IV

### Preparation of Quatraphenyl Amine

A 250 milliliter three-necked round bottom flask, equipped with a mechanical stirrer and purged with argon was charged with 21 grams (0.06 moles) of N-(4-n-dodecylphenyl)-N-(3-methylphenyl)amine, 11.2 grams (0.02 moles) of 4′,4″-diiodoquatraphenyl, 15 grams (0.11 moles) of potassium carbonate, 10 grams of copper bronze and 50 milliliters Soltrol® 170 or Isopar M® hydrocarbons. The mixture was heated for 18 hours at 210° C. The product was isolated by the addition of 200 milliliters of octane and hot filtered to remove inorganic solids. The product crystallized out upon cooling and was isolated by filtration. Treatment with alumina yielded pure N,N′-bis(3-methylphenyl)-N,N′-bis(4-n-dodecylphenyl)(p-quatraphenyl)-4,4′″-diamine colorless crystals with a melting point of 185-187° C. in approximately 60% yield. The structure of this (molecule #4) is:

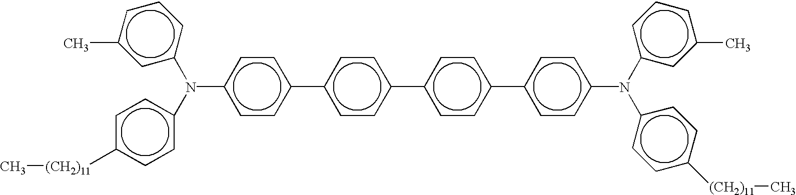

### COMPARATIVE EXAMPLE V

### Starting compounds using N-(4-n-butylphenyl)-N-(4-t-butylphenyl)amine

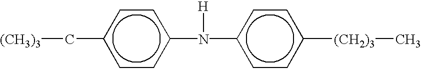

### Preparation of N,N′-bis(4-n-butylphenyl)-N,N′-bis(4-t-butylphenyl)-1,4-phenylenediamine (molecule #5)

The same equipment and conditions as in Example I were employed with the following charge: 16.5 grams (0.05 moles) diiodobenzene, 33 grams (0.12 moles) N-(4-n-butylphenyl)-N-(4-t-butylphenyl)amine, 22.4 grams (0.4 moles) potassium hydroxide, 5 grams copper powder and 25 milliliters Isopar M®. The intended product was obtained as a colorless product with a melting point of 134-135° C. The structure is:

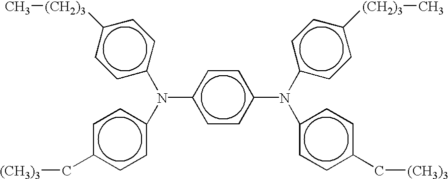

### COMPARATIVE EXAMPLE VI

### Preparation of N,N′-bis(4-n-butylphenyl)-N,N′-bis(4-t-butylphenyl)-(1,1′-biphenyl)-4,4′-diamine (molecule #6)

The same equipment and conditions as in Example II were employed with the following charge: 20.2 grams (0.05 moles) 4,4′-diiodobiphenyl, 33 grams (0.12 moles) N-(4-n-butylphenyl)-N-(4-t-butylphenyl)amine, 22.4 grams (0.4 moles) potassium hydroxide, 5 grams copper powder and 25 milliliters Isopar M®. The intended product was obtained as a colorless product with a melting point of 190-192° C. The structure is:

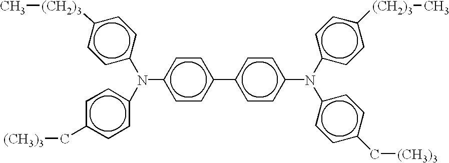

### COMPARATIVE EXAMPLE VII

### Preparation of N,N′-bis(4-n-butylphenyl) -N,N′-bis(4-t-butylphenyl)-(p-terphenyl)-4,4″-diamine (molecule #7)

The same equipment and conditions as in Example III were employed with the following charge: 48 grams (0.1 moles) 4,4″-diiodoterphenyl, 66 grams (0.24 moles) N-(4-n-butylphenyl)-N-(4-t-butylphenyl)amine, 44.8 grams (0.8 moles) potassium hydroxide, 10 grams copper powder and 50 milliliters Isopar M®. The intended product was obtained as a pale yellow product with a melting point of 184-186° C. The structure is:

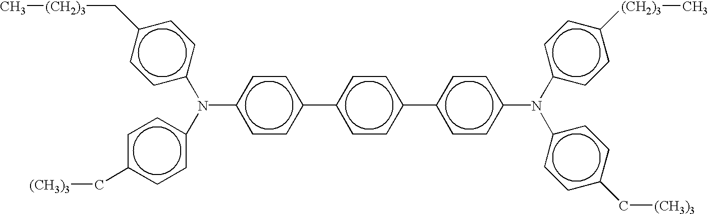

### EXAMPLE VIII

### Preparation of N,N′-bis(4-n-butylphenyl)-N,N′-bis(4-t-butylphenyl)-(p-quatraphenyl)-4,4′″-diamine (molecule #8)

The same equipment and conditions as in Example IV were employed with the following charge: 19 grams (0.034 moles) 4,4′″-diiodoquatraphenyl, 29 grams (0.102 moles) N-(4-n-butylphenyl)-N-(4-t-butylphenyl)amine, 16 grams (0.29 moles) potassium hydroxide, 4 grams copper powder and 20 milliliters Isopar M®. The intended product was obtained as a yellow product with a melting point of 132-134° C. The structure is:

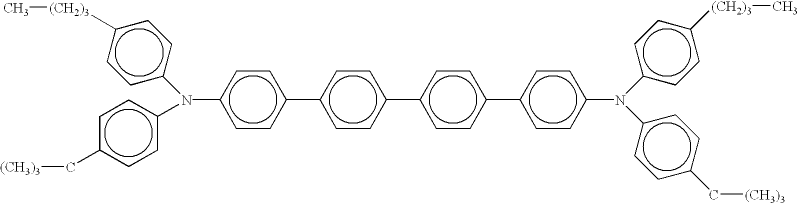

### EXAMPLE IX

Several photoreceptors were prepared by forming coatings using conventional techniques on a substrate comprising a vacuum deposited titanium layer on a polyethylene terephthalate film. The first coating formed on the titanium layer was a siloxane barrier layer formed from hydrolyzed gamma aminopropyltriethoxysilane having a thickness of 0.005 micrometer (50 Angstroms). The barrier layer coating composition was prepared by mixing 3-aminopropyltriethoxysilane (available from PCR Research Center Chemicals of Florida) with ethanol in a 1:50 volume ratio. The coating composition was applied by a multiple clearance film applicator to form a coating having a wet thickness of 0.5 mil. The coating was then allowed to dry for 5 minutes at room temperature, followed by curing for 10 minutes at 110 degree centigrade in a forced air oven. The second coating was an adhesive layer of polyester resin (49,000, available from E.I. duPont de Nemours & Co.) having a thickness of 0.005 micron (50 Angstroms). The second coating composition was applied using a 0.5 mil bar and the resulting coating was cured in a forced air oven for 10 minutes. This adhesive interface layer was thereafter coated with a photogenerating layer containing 40 percent by volume hydroxygallium phthalocyanine and 60 percent by volume of a block copolymer of styrene (82 percent)/4-vinyl pyridine (18 percent) having a Mw of 11,000. This photogenerating coating composition was prepared by dissolving 1.5 grams of the block copolymer of styrene/4-vinyl pyridine in 42 ml of toluene. To this solution was added 1.33 grams of hydroxygallium phthalocyanine and 300 grams of ⅛ inch diameter stainless steel shot. This mixture was then placed on a ball mill for 20 hours. The resulting slurry was thereafter applied to the adhesive interface with a Bird applicator to form a layer having a wet thickness of 0.25 mil. This layer was dried at 135° C. for 5 minutes in a forced air oven to form a photogenerating layer having a dry thickness 0.4 micrometer.

### EXAMPLE X

Four transport layers were coated on the generator layers of Example IX. The four molecules employed to coat the four transport layers were: (1) N,N′-bis(4-n-butylphenyl)-N,N′-bis(4-t-butylphenyl)-1,4-phenylenediamine (molecule #5), (2) N,N′-bis(4-n-butylphenyl)-N,N′-bis(4-t-butylphenyl)-( 1,1′-biphenyl)-4,4′-diamine (molecule #6), (3) N,N′-bis(4-n-butylphenyl)-N,N′-bis(4-t-butylphenyl)-(p-terphenyl)-4,4″-diamine (molecule #7), (4) N,N′-bis(4-n-butylphenyl) -N,N′-bis(4-t-butylphenyl)-(p-quatraphenyl)-4,4′″-diamine (molecule #8). The transport layer was formed by using a Bird coating applicator to apply a solution containing one gram of the molecule and three grams of polycarbonate resin (poly(4,4′-isopropylidene-diphenylene carbonate, available as Makrolon R from Farbenfabricken Bayer A.G.) dissolved in 35 grams of methylene chloride solvent. The coated device was dried at 80° C. for half an hour in a forced air oven to form a dry 25 micrometers thick charge transport layer.

### EXAMPLE XI

Semitransparent gold electrodes were vaccum deposited on the four devices of Example X. Each one of the electroded devices is connected in an electrical circuit containing a power supply and a current measuring resistance. The transit time of the carriers is determined by the time of flight technique. This is accomplished by biasing the gold electrode negative and exposing the device to a short flash of light. Holes photogenerated in the generator layer are injected into and transit through the transport layer. The current due to the transit of a sheet of holes is time resolved and displayed on an oscilloscope. The current pulse consists of a flat portion followed by a rapid decrease. The flat portion is due to the transit of the sheet of holes through the transport layer. The rapid drop of current signals the arrival of the holes at the negative electrode. From the transit time, the velocity of the carriers is calculated by the relation: velocity=transport layer thickness divided by the transit time. The hole mobility is related to the velocity by the relation: velocity=(mobility) X (electric field).

| Molecule ID | Low field mobility |
|---|---|
| #5 | 4.5 × 10⁻⁹ |
| #6 | 4 × 10⁻⁸ |
| #7 | 5 × 10⁻⁷ |
| #8 | 9 × 10⁻⁷ |

A systematic increase in mobility (units of cm²/(volt sec)) was obtained as the number of phenyl groups between the nitrogen atoms was increased. Among the four molecules containing one, two, three and four unsubstituted phenyl groups between the nitrogen atom, the highest mobility was obtained for the molecule with four para-conjugated unsubstituted phenyl groups between the nitrogen atoms.

What is claimed is:

1. An electrophotographic imaging member comprising
a conductive layer,
an optional charge blocking layer,
an optional adhesive layer,
a charge generator layer, and
a charge transport layer comprising a charge transporting molecule comprising an aryldiamine having the formula
(X-Ph)(Y-Ph)-N-(Ph)ₙ-N-(Ph-Y)(Ph-X),
wherein Ph represents a phenyl group and in which (Ph)ₙ consists of para-conjugated unsubstituted phenyl groups, X represents a hydrogen atom or an alkyl group having from 1 to about 20 carbon atoms, Y represents a hydrogen atom or an alkyl group having from 1 to about 20 carbon atoms, and n is an integer greater than 3, molecularly dispersed or dissolved in a polymeric binder, wherein the charge transporting molecule is present in an amount of from about 10 and about 80 percent by weight based on the total weight of the charge transport layer.

2. The electrophotographic imaging member according to claim 1, wherein the charge transporting molecule comprises an aryldiamine in which n is 4.

3. The electrophotographic imaging member according to claim 1, wherein the charge transporting molecule comprises an aryldiamine in which n is an integer of from 5 to 10.

4. The electrophotographic imaging member according to claim 1, wherein the charge transporting molecule is present in an amount of from about 10 and about 50 percent by weight based on the total weight of the charge transport layer.

5. The electrophotographic imaging member according to claim 1, wherein the polymeric binder is selected from the group consisting of polycarbonates, polyesters, polystyrenes, polyarylates, polyacrylates, polyethers, polysulfones and mixtures thereof.

6. The electrophotographic imaging member according to claim 1, wherein the charge generator layer comprises a charge generating pigment dispersed in a polymeric binder.

7. The electrophotographic imaging member according to claim 6, wherein the charge generating pigment comprises trigonal selenium, benzamidazole perylene, chlorogallium pthalocyanine or hydroxygallium phthalocyanine.

8. An electrophotographic image forming device comprising
an imaging member comprised of
a conductive layer,
a charge generator layer, and
a charge transport layer comprising a charge transporting molecule comprising an aryldiamine having the formula
(X-Ph)(Y-Ph)-N-(Ph)ₙ-N-(Ph-Y)(Ph-X),
wherein Ph represents a phenyl group and in which (Ph)ₙ consists of paraconjugated unsubstituted phenyl groups, X represents a hydrogen atom or an alkyl group having from 1 to about 20 carbon atoms, Y represents a hydrogen atom or an alkyl group having from 1 to about 20 carbon atoms, and n is an integer greater than 3, molecularly dispersed or dissolved in a polymeric binder, wherein the charge transporting molecule is present in an amount of from about 10 and about 80 percent by weight based on the total weight of the charge transport layer,
a charging device,
an electrostatic image forming station,
an image developing station, and
an image transfer station.

9. The electrophotographic image forming device according to claim 8, wherein the charge transporting molecule comprises an aryldiamine in which n is 4.

10. The electrophotographic imaging member according to claim 8, wherein the charge transporting molecule comprises an aryldiamine in which n is an integer of from5to 10.

11. An electrophotographic imaging member comprising
a conductive layer,
an optional charge blocking layer,
an optional adhesive layer,
a charge generator layer, and
a charge transport layer comprising a charge transporting molecule comprising an aryldiamine having the formula
(X-Ph)(Y-Ph)-N-(Ph)ₙ-N-(Ph-Y)(Ph-X),
wherein Ph represents a phenyl group and in which (Ph)ₙ consists of ortho-conjugated unsubstituted phenyl groups, para-conjugated unsubstituted phenyl groups, or both, X represents a hydrogen atom or an alkyl group having from 1 to about 20 carbon atoms, Y represents a hydrogen atom or an alkyl group having from 1 to about 20 carbon atoms, and n is an integer greater than 3, molecularly dispersed or dissolved in a polymeric binder, wherein the charge transporting molecule is present in an amount of from about 10 and about 80 percent by weight based on the total weight of the charge transport layer.

12. The electrophotographic imaging member according to claim 11, wherein the charge transporting molecule comprises an aryldiamine in which n is 4.

13. The electrophotographic imaging member according to claim 11, wherein the charge transporting molecule comprises an aryldiamine in which n is an integer from 5 to 10.

14. An electrophotographic image forming device comprising
the electrophotographic imaging member according to claim 11,
a charging device,
an electrostatic image forming station,
an image developing station, and
an image transfer station.
